(19) United States
(12) Patent Application Publication
(10) Pub. No.: US 2021/0402413 A1
(43) Pub. Date: Dec. 30, 2021

(54) TOWER-TYPE AIR PURIFICATION APPARATUS AND AIR PURIFICATION METHOD THEREOF

(71) Applicants: Hyun Min KIM, Seoul (KR); ONNURI COMPANY LC., Seoul (KR)

(72) Inventor: Hyun Min KIM, Seoul (KR)

(73) Assignees: Hyun Min KIM, Seoul (KR); ONNURI COMPANY LC., Seoul (KR)

(21) Appl. No.: 17/471,399

(22) Filed: Sep. 10, 2021

Related U.S. Application Data
(63) Continuation of application No. PCT/KR2020/003162, filed on Mar. 6, 2020.

(30) Foreign Application Priority Data
Mar. 10, 2019 (KR) 10-2019-0027253

(51) Int. Cl. B03C 3/014; B01D 47/06; B03C 3/38; B03C 3/011; B03C 3/45; B03C 3/60; B03C 3/78; B03C 3/88; B03C 3/12; B03C 3/10; F24F 8/117; F24F 8/192; F24F 8/30

(52) U.S. Cl. CPC B03C 3/014; B01D 47/06; B03C 3/38; B03C 3/011; B03C 3/45; B03C 3/60; B03C 2201/24; B03C 3/88; B03C 3/12; B03C 3/10; F24F 8/117; F24F 8/192; F24F 8/30; B03C 3/78

(57) ABSTRACT

The present disclosure relates to a tower type air purifier installed and operated outdoors to purify air pollutants such as fine dust. More particularly, the tower type air purifier is manufactured by modularizing and combining main constituent components of a main body in a tower form in order to easily separate and purify air pollutants in the air. A controller, which prepares an air purification algorithm based on air pollution measurement information, controls a blower, a mist sprayer, an ion emitter, a cleaning water injector and an adsorption brush installed in the purifier to quickly purify a large amount of suctioned air. The purifier can be operated independently or a group of purifiers can be operated through remote control according to an air purification algorithm suitable for each air pollution region and provided from a weather center.

### CROSS-REFERENCE TO RELATED APPLICATIONS

This application is a continuation of International Application No. PCT/KR2020/003162 filed on Mar. 6, 2020, which claims priority to Korean Patent Application No. 10-2019-0027253 filed on Mar. 10, 2019, the entire contents of which are herein incorporated by reference.

### TECHNICAL FIELD

The present disclosure relates to a tower-type air purification apparatus installed and operated outdoors to purify air pollutants such as fine dust.

### BACKGROUND

Air pollution caused by fine dust, ultrafine dust, yellow dust, dust, etc., which is getting worse day by day, is becoming a serious environmental problem globally across regions and borders. However, there is no suitable solution but to go out less frequently and wear a mask in response to an air pollution alert. Thus, damage to daily life and health care is increasing due to air pollution.

Accordingly, the governments of various countries have come up with measures to reduce fine dust in various ways. However, due to increasing automobiles, industrial pollution, fire and generation of various types of dust, generation of fine dust and ultrafine dust is getting worse and worse. Therefore, fine dust pollution is becoming the biggest risk factor threatening public health to a disaster level.

Home and industrial air purifiers using filters for adsorbing fine dust have been developed in various ways and have been widely distributed. However, conventional air purifiers using general air purification filters cannot purify enormous amounts of air pollutants. So far, there are few air pollution purifiers that can effectively solve this problem.

Accordingly, in some regions, cleaning vehicles equipped with a mist sprayer drive on the road to spray mist particles into the air or mist sprayers that spray mist particles into the air are installed and operated every day when fine dust is severe. In some countries, giant air purifier towers are installed and tested in urban areas. Also, artificial rainfall tests using airplanes are attempted, and efforts are being made to lower the concentration of fine dust.

However, spraying of mist particles from cleaning vehicles or artificial rainfall using airplanes, which are temporarily conducted only in specific regions on severe fine dust days, have a limited scope of application depending on the weather conditions and regions, and, thus, the effect of reducing fine dust is insignificant. Also, it is difficult to supply large numbers of giant air purifier towers, which are tested in some countries, due to high cost of necessary construction sites, installation and replacement of air purification filters.

Air pollution is caused by various pollution components such as yellow dust, fine dust, ultrafine dust, dust, pollen, etc. Also, the type and concentration of air pollutants vary depending on the weather conditions, and the air pollution region is vast. Thus, a general air purification method using air purification filters practically difficult to use because it is impossible to handle an enormous air purification filter that must be replaced every day.

### DISCLOSURE OF THE INVENTION

### Problems to be Solved by the Invention

The present disclosure is conceived to provide an air purification means that can be easily installed on the roof of a building, on a roadside, on a riverside, etc. and can quickly purify a large amount of air without using a general air purification filter as an purification means capable of effectively purifying a large amount of air is required to handle air pollutants and concentrations of various components.

The present disclosure relates to a tower type air purifier installed and operated outdoors to purify air pollutants such as fine dust. More specifically, the tower type air purifier is manufactured by modularizing and combining main constituent components of a main body in a tower form in order to easily separate and purify air pollutants in the air. The present disclosure provides a controller, which has an air purification algorithm based on air pollution measurement information, to quickly purify a large amount of air suctioned by controlling a blower, a mist sprayer, an ion emitter, a cleaning water injector and an adsorption brush installed in the purifier. The present disclosure to provide a tower type air purifier and an air purification method by which the purifier can be operated independently or a group of purifiers can be operated through remote control according to an air purification algorithm suitable for each region and provided from a weather center via a network.

The tower type air purifier of the present disclosure includes an air suction unit (equipped with a mist sprayer, an ion emitter, a cleaning water injector), an air diffusion unit, an air purification unit, a pollutant collection unit, a pollutant precipitation unit and a pollutant discharge unit as main constituent components. The present disclosure provides a tower type air purifier and an air purification method by which a controller independently operates the air purifier according to an air purification algorithm depending on air pollution sensor information or the air purifier is remotely controlled to perform air purification according to an air purification algorithm of a weather center.

### Means for Solving the Problems

An aspect of the present disclosure provides a tower type air purifier.

The tower type air purifier according to the present disclosure includes: an air suction unit equipped with one or more blowers and configure to suction air; a mist sprayer provided in the air suction unit and configured to spray mist particles; an ion emitter provided in the air suction unit and configured to emit ions; a cleaning water injector provided in the air suction unit and configured to inject cleaning water; an air diffusion unit provided under the air suction unit and configured to diffuse the suctioned air; an air purification unit provided under the air diffusion unit and including at least one adsorption brush; a pollutant collection unit provided under the air purification unit and configured to collect pollutants coming out from the air purification unit; a pollutant precipitation unit provided under the pollutant collection unit and configured to discharge the purified air through a ventilation opening, collect the pollutants coming out from the pollutant collection unit and precipitate the pollutants; and a pollutant discharge unit provided under the pollutant precipitation unit and configured to discharge the precipitated pollutants. The tower type air purifier according to the present disclosure may further include a controller provided in a main body, connected to a remote control center via a network and configured to control operations of the respective constituent components according to a prepared air purification algorithm; and an air pollution sensor provided in the main body and configured to provide air pollution measurement information to the controller.

In the tower type air purifier according to the present disclosure, the operations of the blower, the mist sprayer, the ion emitter, the cleaning water injector and the adsorption brush are controlled according to the prepared air purification algorithm of the controller depending on measurement information from the air pollution sensor to purify and discharge the suctioned air through the air suction unit, the air purification unit, the pollutant collection unit and the pollutant precipitation unit.

In order to further improve the means for solving the above problems and to effectively implement the tower type air purifier of the present disclosure, the main constituent components are included as follows.

Each of the pollutant collection unit and the pollutant precipitation unit is formed into a funnel shape in order to facilitate pollutant collection and precipitation. Also, a separation space having a distance from each other between the pollutant collection unit and the pollutant precipitation unit is formed to discharge the purified air and collect pollutants.

The adsorption brush is configured to purify air by adsorbing pollutant particles in the air while the main body is rotated. A rotation speed is controlled to purify air according to the air purification algorithm of the controller. Also, the adsorption brush is formed by spirally arranging numerous conductive brush pins on a pipe-shaped main body. When the main body is rotated, the spiral-shaped brush pushes air downwards and adsorbs pollutant particles.

Also, the adsorption brush is electrically charged under the control of the controller, and the electrically charged brush electrostatically adsorbs pollutant particles electrically charged by ions from the ion emitter to purify air. Further, the adsorption brush includes brush pins coated with a carbon nanotube material or made of plastic containing a carbon nanotube material for conductivity and durability.

In the air purification unit, at least two adsorption brushes are vertically or horizontally arranged depending on the size of the purifier and individually rotated. Further, a plurality of pollutant collection plates configured to collect pollutants, which are discharged by a centrifugal force of the adsorption brush that has adsorbed the pollutant particles, is further provided along an inner circumference of the air purification unit.

A waterproof cover having a distance from a suction opening of the blower is further provided above the blower in order to block rain and snow flowing into the blower. A solar panel on an upper end of the waterproof cover, which is installed at a slant in order to suppress accumulation of snow or dust, may be provided to use electricity generated from the solar panel by photovoltaic power generation in the purifier and thus save operating energy.

The controller is switched to a remote control mode by the remote control center. When the controller is switched to the remote control mode, an air purification function of the purifier is performed according to an air purification algorithm of the remote control center.

An air purification method performed by the tower type air purifier according to the present disclosure is as follows.

The air purification method of the tower type air purifier according to the present disclosure includes: a process of starting control of constituent components by a controller according to an air purification algorithm; a process of measuring pollutants in air and a concentration of pollutants by operating an air pollution sensor; a process of suctioning outside air by controlling a blower of an air suction unit; a process of spraying mist into the suctioned air by controlling a mist sprayer of the air suction unit; a process of emitting ions into the suctioned air by controlling an ion emitter of the air suction unit; a process of adsorbing and discharging pollutant particles in the air by controlling rotation and electric charging of an adsorption brush of an air purification unit; a process of narrowly injecting cleaning water into the suctioned air to clean insides of the adsorption brush and the air purification unit by controlling a cleaning water injector of the air suction unit; and a process of discharging the pollutants precipitated in a pollutant precipitation unit by controlling an ejector of a pollutant discharge unit.

In order to further improve the means for solving the above problems and to effectively implement air purification through the tower type air purifier of the present disclosure, an air purification algorithm as an efficient air purification method is prepared as follows.

The air purification algorithm of the controller may include the following processes:

(a) a process of starting the air purification algorithm;

(b) a process of measuring pollutants in air and a concentration of pollutants by operating an air pollution sensor;

(c) a process of collecting monitoring sensor information of the constituent components inside the purifier;

(d) a process of suctioning air by controlling the blower of the air suction unit to vary a volume of air to be suctioned depending on air to be purified;

(e) a process of selecting an air purification method according to the air purification algorithm based on the air pollution measurement information of the process (b) (for example, The concentration of fine dust/yellow dust is high? YES if high or NO if low);

(f) a first air purification method for performing an air purification process as follows according to the air purification algorithm if the concentration of fine dust/yellow dust is lower than a set value in the process (e);

(1) a process of emitting ions into the suctioned air by controlling an ion emitter of the air suction unit air suction unit

(2) a process of electrostatically adsorbing pollutant particles in the air by the electrically charged adsorption brush by controlling the adsorption brush of the air purification unit

(3) a process of spraying mist into the suctioned air by controlling the mist sprayer of the air suction unit

(4) a process of adsorbing the pollutant particles and discharging the adsorbed pollutant particles by controlling rotation of the adsorption brush of the air purification unit to vary a rotation speed according to the air purification algorithm

(5) a process of cleaning the insides of the adsorption brush and the air purification unit with the injected cleaning water by controlling the cleaning water injector of the air suction unit

(6) a process of performing air purification by repeating the processes (1) to (5) based on the air pollution measurement information and the monitoring sensor information of the constituent components

(g) a second air purification method for performing an air purification process as follows according to the air purification algorithm if the concentration of fine dust/yellow dust is higher than the set value in the process (e);

(1) a process of spraying mist into the suctioned air by controlling the mist sprayer of the air suction unit

(2) a process of narrowly injecting the cleaning water into the suctioned air (yellow dust high-concentration pollutant particles) to adsorb the pollutant particles in the air and clean the adsorption brush by controlling the cleaning water injector of the air suction unit

(3) a process of adsorbing the pollutant particles and discharging the adsorbed pollutant particles by controlling rotation of the adsorption brush of the air purification unit to vary a rotation speed according to the air purification algorithm

(4) a process of cleaning the insides of the adsorption brush and the air purification unit with the strongly injected cleaning water by controlling the cleaning water injector of the air suction unit

(5) a process of performing air purification by repeating the processes (1) to (4) based on the air pollution measurement information and the monitoring sensor information of the constituent components

(h) a process of discharging the pollutants precipitated on the bottom of the pollutant precipitation unit into a collection container by controlling the ejector of the pollutant discharge unit based on monitoring sensor information of the pollutant precipitation unit.

### Effects of the Invention

A tower type air purifier of the present disclosure is installed and operated outdoors to purify air pollutants such as fine dust, and may be installed on the roof of a building, on a roadside, on a riverside, etc. and thus may be usefully used as an air pollution purifier to protect public health against air pollution.

Also, the tower type air purifier of the present disclosure uses an adsorption brush of the present disclosure, which can be used semipermanently, to purify air by quickly adsorbing pollutant particles in the air. Since the tower type air purifier of the present disclosure does not use a general air purification filter, it requires lower operating cost and is easy to maintain. Thus, it is possible to economically purify air pollution.

Further, in the tower type air purifier of the present disclosure, the purifier can be operated independently based on air pollution sensor information according to an air purification algorithm of the present disclosure or a group of purifiers can be operated through remote control according to an air purification algorithm suitable for each air pollution region and provided from a weather center in order to effective purify fine dust, ultrafine dust, yellow dust, dust and pollen which are types of air pollutants. It is possible to effectively and quickly purify air pollution in a wide area.

### BRIEF DESCRIPTION OF THE DRAWINGS

FIG. 1 illustrates main constituent components of a tower type air purifier according to the present disclosure.

FIG. 2 illustrates a process of performing air purification by emitting ions and spraying mist from an air suction unit of the tower type air purifier according to the present disclosure and operating an adsorption brush of an air purification unit.

FIG. 3 illustrates a process of performing air purification by spraying mist and injecting cleaning water from the air suction unit of the tower type air purifier according to the present disclosure and operating the adsorption brush of the air purification unit.

FIG. 4 shows an embodiment in which a waterproof cover and a safety ring are installed at an upper part of the tower type air purifier according to the present disclosure.

FIG. 5 shows an embodiment of the adsorption brush according to the present disclosure.

FIG. 6 shows another embodiment in which four adsorption brushes according to the present disclosure are horizontally arranged and installed depending on the size of an air purifier to be manufactured.

FIG. 7 is a block diagram showing a configuration for controlling each function of the tower type air purifier according to the present disclosure.

FIG. 8 is a flowchart showing an embodiment of an air purification algorithm in an air purification method of the tower type air purifier according to the present disclosure.

### DETAILED DESCRIPTION

Details of the above-described objects, technical configurations of the present disclosure as well as operational effects thereof will be clearly understood by the following detailed description based on the accompanying drawings in the specification of the present disclosure.

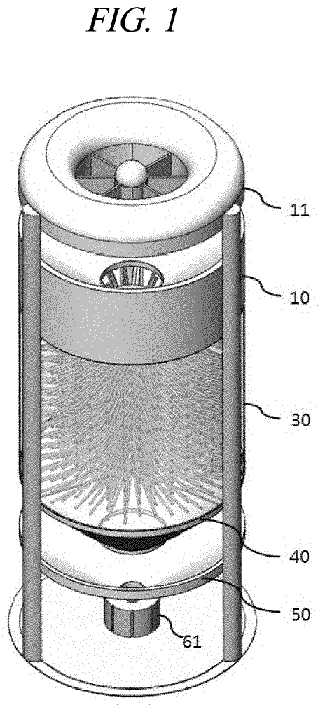

FIG. 1 illustrates main constituent components of a tower type air purifier according to the present disclosure.

Referring to FIG. 1, the tower type air purifier according to the present disclosure is manufactured by combining an air suction unit 10 equipped with at least one blower 11 thereon, an air purification unit 30, a pollutant collection unit 40 and a pollutant precipitation unit 50 in a tower form so as to be supported by a three-legged support. In order to easily separate and purify air pollutants in the air suctioned by the blower 11, the main constituent components 10, 40 and 50 of a main body are formed into a funnel structure.

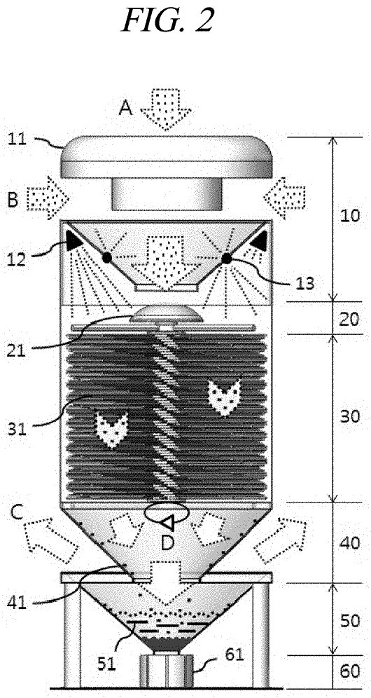

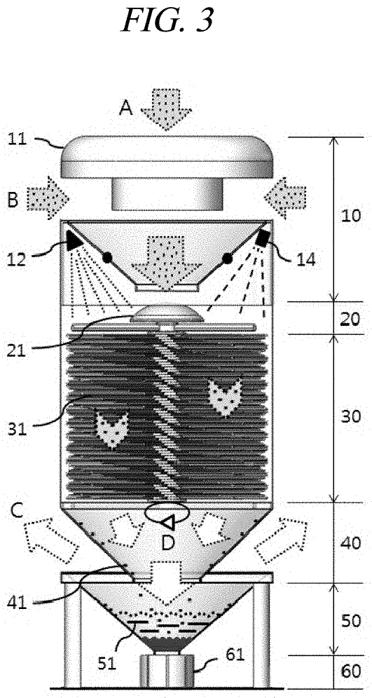

Hereinafter, a process of suctioning polluted air and purifying the suctioned air through the tower type air purifier according to the present disclosure will be described in detail with reference to FIG. 2 and FIG. 3.

FIG. 2 illustrates a process of performing air purification by emitting ions and spraying mist from an air suction unit of the tower type air purifier according to the present disclosure and operating an adsorption brush of an air purification unit. FIG. 3 illustrates a process of performing air purification by spraying mist and injecting cleaning water from the air suction unit of the tower type air purifier according to the present disclosure and operating the adsorption brush of the air purification unit.

Referring to FIG. 2 and FIG. 3, the blower 11 is operated above the air suction unit 10 at a distance from an inlet opening of the air suction unit 10 formed into a funnel structure in order to suction a large amount of air with small energy. When the blower 11 is operated, a large amount of air may be suctioned into the air suction unit 10 together with air B from lateral sides due to an air current of wind A blown from above. Depending on the size and air purification capability of the air purifier, a large blower 11 may be installed at the suction opening or a combination of a plurality of blowers 11 may be installed at the suction opening. Depending on the structure of the suction opening, a plurality of blowers 11 may also be installed on side surfaces.

Further, the air suctioned inwards through a discharge opening of the air suction unit 10 is diffused widely in all directions by a semicircular air diffusion plate 21, and a vortex is generated by an ascending air current and the suctioned air current. Thus, pollutant particles in the air may be absorbed by mist particles in a process of mixing the pollutant particles with the mist particles sprayed by a plurality of mist sprayers 12. Desirably, an air diffusion fan may be added to the air diffusion plate 21 and rotated for smooth mixing of the mist particles and the pollutant particles.

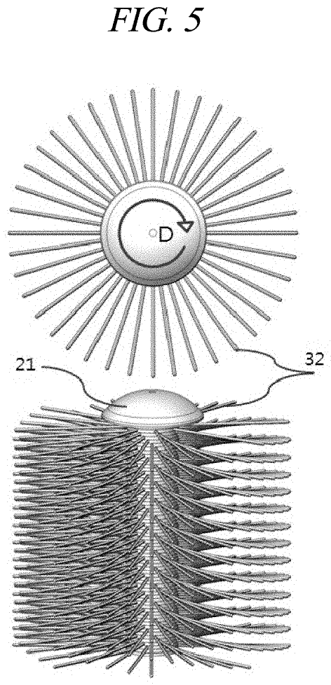

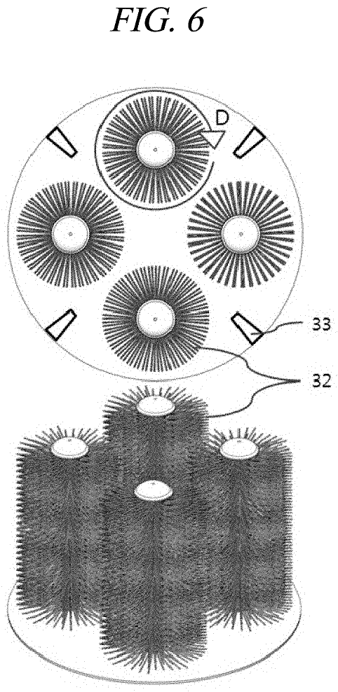

Therefore, through the air suction unit 10 and the air diffusion unit 20, pollutant particles in the air are absorbed by the sprayed mist particles, and while the adsorption brush 31 is rotated, and the mist particles that absorbed the pollutant particles are hit and adsorbed by numerous brush pins. In the adsorption brush 31, numerous brush pins are arranged in a spiral shape. Thus, when the adsorption brush 31 is rotated, the adsorption brush 31 quickly adsorbs the mist particles that absorbed the pollutant particles while pushing air downwards in a spiral blade shape. Therefore, it is possible to effectively purify a large amount of air. The detailed structure and operational effects of the adsorption brush 31 will be described in more detail with reference to FIG. 5 and FIG. 6.

FIG. 2 is a diagram for explaining a process of purifying fine dust or ultrafine dust at a low air pollution concentration. The air A and B suctioned by the blower 11 of the air suction unit 10 is widely diffused by the air diffusion plate 21. According to the air purification algorithm depending on the type and concentration of pollutants in the suctioned air, a controller 70 operates a plurality of mist sprayers 12 and a plurality of ion emitters 13 alternately or simultaneously. After ions are emitted and mist is sprayed into the suctioned air, the electrically charged adsorption brush 31 quickly adsorbs the pollutant particles (mist particles with pollutants), which were absorbed by the mist particles and electrically charged by the ions, while being rotated at an appropriate speed D. Thus, air purification is effectively performed.

The ion emitter 13 emits ions into the suctioned air at the inlet opening of the air suction unit 10 formed into a funnel structure in order to sufficiently ionize the pollutant particles in the suctioned air. As shown in the drawing, ions are also emitted into the diffused air from an inner wall of the air suction unit 10. Accordingly, a plurality of ion emitters 13 may be installed inside/outside the air suction unit 10 depending on the size of the air purifier and the amount of air to be suctioned. The ion emitter 13 controlled by the controller 70 may emit ions in a suitable direction and in a suitable amount for air to be suctioned according to the air purification algorithm.

In the air purification unit 30, when the adsorption brush 31 that adsorbed the pollutant particles (mist particles with pollutants) in the above-described air purification process is quickly rotated D, the pollutant particles adsorbed by the adsorption brush 31 are discharged to an inner wall of the air purification unit 30 by a centrifugal force and thus become pollutants. Discharged pollutants 41 may be swept away by the rotation of the adsorption brush 31 and collected in the funnel-shaped pollutant collection unit 40, and then may fall down through a discharge opening.

Air C purified through the above-described process may exit from the discharge opening of the pollutant collection unit 40 and may be discharged to the outside through a ventilation opening of the pollutant precipitation unit 50. The pollutants 41 falling down through the discharge opening may be collected in the pollutant precipitation unit 50 and quickly precipitated by precipitation water 51 which is slopped by force of the air coming out from the discharge opening. When the amount of precipitated pollutants reaches a certain level, an ejector 61 of a pollutant discharge unit 60 may be operated by a monitoring sensor, and the pollutants may be discharged into a collection container through a pipe. If a filter is added when the pollutants are discharged, it is easy to collect the pollutants.

Further, each of the pollutant collection unit 40 and the pollutant precipitation unit 50 may be formed into a funnel shape in order to facilitate collection and precipitation of the pollutants 41. Desirably, a V-shaped separation space having a distance from each other between the pollutant collection unit 40 and the pollutant precipitation unit 50 may be formed to discharge the purified air C and collect the pollutants. Also, desirably, an ultrasonic generator or a bubble generator may be further installed in the pollutant precipitation unit 50 to emit ultrasonic waves or bubbles into the precipitation water 51 in order to effectively precipitate the pollutants.

In the air purification process, the cleanliness inside the purifier may be monitored by a monitoring sensor according to the air purification algorithm and a plurality of cleaning water injectors 14 may be periodically operated to clean the adsorption brush 31 and the inner walls of the air purification unit 30 and the air suction unit 10. Thus, the air purifier can be maintained at an optimal operation state. Desirably, an eco-friendly detergent may be added to cleaning water depending on the cleaning situation.

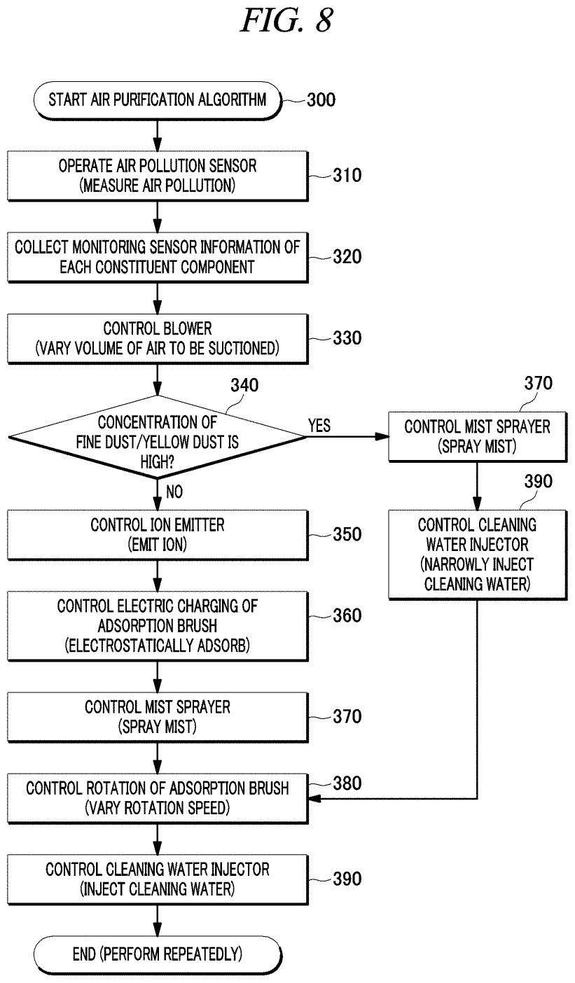

The adsorption brush 31, which is a key component of the tower type air purifier according to the present disclosure, can be appropriately controlled for purification of air pollution according to the air purification algorithm of the controller 70 according to the present disclosure. The adsorption brush 31 may be periodically charged by a pulse voltage or may be rotated at a suitable speed D depending on the measured type and concentration of air pollutants during the air purification process. Thus, the adsorption brush 31 can quickly and effectively adsorb and discharge the pollutant particles in the air. An air purification method according to the air purification algorithm will be described below in detail with reference to FIG. 8.

FIG. 3 is a diagram for explaining a process of purifying yellow dust or fine dust at a high air pollution concentration. Air A and B suctioned by the blower 11 of the air suction unit 10 is widely diffused through the air diffusion plate 21. The controller operates a plurality of mist sprayers 12 and a plurality of cleaning water injectors 14 alternately or simultaneously. After mist particles are sprayed and cleaning water was narrowly injected into the polluted air diffused in the container, the adsorption brush 31 of air purification unit 30 quickly adsorbs the pollutant particles (mist particles with pollutants, and cleaning water with pollutants), which were absorbed by the mist particles and the cleaning water, while being rotated D. Thus, air purification is effectively performed.

Then, as for purified air C and the pollutants 41 discharged from the air purification unit 30, the pollutants 41 are collected by the pollutant collection unit 40 and fall down, and the purified air C is discharged to the outside through the separation space of the pollutant precipitation unit 50. After the pollutants 41 falling down into the pollutant precipitation unit 50 are precipitated by the precipitation water 51, the pollutants 41 may be discharged from the pollutant discharge unit 60 to the outside. The detailed air purification process illustrated in FIG. 3 is similar to the air purification process illustrated in FIG. 2 and repeated description will be omitted.

As illustrated in FIG. 3, yellow dust or high-concentration fine dust is strongly adsorbed to the internal components of the adsorption brush 31 and the air purification unit 30 due to the nature of the pollutants. Since mist spraying alone may have a low cleaning effect of the internal components, a large amount of mist may be sprayed and a large amount of cleaning water may also be narrowly injected into the suctioned air to increase an absorption rate of the pollutants by the sprayed mist particles and the injected cleaning water and to improve a cleaning effect of the internal components with the cleaning water.

Therefore, the air purification method of the present disclosure requires an effective air purification means capable of effectively performing the air purification process depending on the type and concentration of air pollutants suctioned into the purifier. To do this automatically and smoothly, an air purification algorithm is prepared based on air pollution measurement information and an air purification process suitable for air pollution can be performed by operating the purifier alone or through remote control from the weather center.

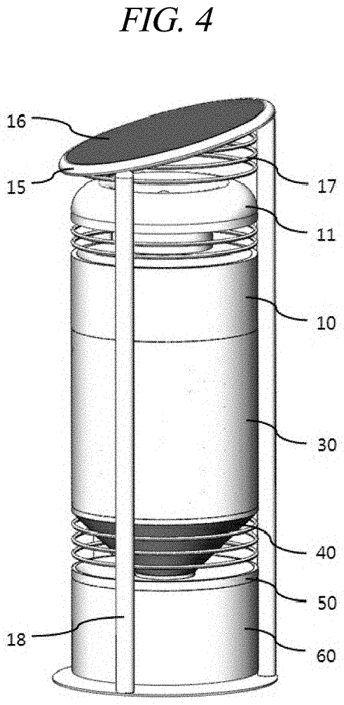

FIG. 4 shows an exemplary embodiment of the present disclosure in which a waterproof cover and a safety ring are installed at an upper part of the tower type air purifier according to the present disclosure.

FIG. 4 illustrates the tower type air purifier according to the present disclosure equipped with a safety ring 17 in a separation space of the blower 11, the air suction unit 10 and the pollutant precipitation unit 50 to suppress intrusion of pigeons or animals and a waterproof cover 15 installed at a slant above the blower 11 to block rain and snow flowing into the suction opening for safe practical use of the tower type air purifier according to the present disclosure shown in FIG. 1. In order to increase the safety against intrusion, wire mesh may also be provided along an inner circumference of the safety ring 17.

Further, the tower type air purifier according to the present disclosure includes a solar panel 16 for photovoltaic power generation added to the slope of the waterproof cover 15 for energy saving. Desirably, electricity generated from the solar panel 16 may be used as an auxiliary power source for the air purifier.

Furthermore, the tower type air purifier according to the present disclosure is stably supported by a three-legged support 18. The main constituent components 10, 11, 15, 17, 30, 40, 50 and 60 constituting the air purifier may be modularized and combined in a tower form in the three-legged support 18. Therefore, these main constituent components can be easily replaced or maintained as a module unit.

Accordingly, the tower type air purifier according to the present disclosure, which is provided with the main constituent components in the form of a module, is easy to move and install even if it is manufactured in a large size. Thus, it can be easily installed on the roof of a building, on a roadside, on a riverside, etc. and can be economically operated. Further, stainless steel and FRP molded products that do not rust may be used as exterior materials. Thus, the tower type air purifier according to the present disclosure is easy to maintain and can be used semipermanently.

FIG. 5 shows an embodiment of the adsorption brush according to the present disclosure, and FIG. 6 shows another embodiment in which four adsorption brushes according to the present disclosure are horizontally arranged and installed depending on the size of an air purifier to be manufactured.

FIG. 5 shows an embodiment of the adsorption brush 31 according to the present disclosure, and a main body which is rotated by a built-in motor inside the semicircular air diffusion plate 21 is in the form of a brush in which numerous brush pins 32 are arranged in a spiral shape. In order to quickly perform air purification, the adsorption brush 31 may be rotated D. Desirably, the air diffusion plate 21 may be installed at an upper end of the adsorption brush 31 and they may be configured as a set, and a plurality of sets may be arranged vertically or horizontally depending on the size of the air purifier.

In the adsorption brush 31, the main body performs an air purification function while being rotated D, and a rotation speed is appropriately controlled according to the air purification algorithm of the controller 70 depending on air pollution measurement information. Thus, the adsorption brush 31 can purify air by adsorbing pollutant particles in the air. The adsorption brush 31 may be formed by spirally arranging numerous conductive brush pins 32 on the main body. When the main body is rotated, the adsorption brush 31 quickly adsorbs the pollutant particles while pushing air downwards in a spiral blade shape.

Also, as an embodiment to increase an absorption rate of fine dust by the adsorption brush 31, a plurality of brush pins 32 made like bristles by gathering several strands of piano wire, etc. may be arranged in a spiral shape on the pipe-shaped main body. Desirably, the brush pins 32 may be coated with a conductive material.

Further, the adsorption brush 31 may be electrically charged by a pulse voltage under the control of the controller 70. The electrically charged brush electrostatically adsorbs pollutant particles electrically charged by ions from the ion emitter 13 to purify air. The adsorption brush 31 may include the brush pins 32 coated with a carbon nanotube material or made of plastic containing a carbon nanotube material for conductivity and durability.

FIG. 6 shows another embodiment of the adsorption brush 31 according to the present disclosure in which four adsorption brushes 31 are horizontally arranged and installed depending on the size of an air purifier to be manufactured. A plurality of pollutant collection plates 33 is installed between the arranged adsorption brushes 31. Thus, when the adsorption brushes 31 that adsorbed the pollutants discharge the adsorbed pollutants by a centrifugal force while being rotated (D), the discharged pollutants may be hit by the pollutant collection plates 33 and may be collected more quickly.

Accordingly, the air purification unit 30 may be configured such that at least two adsorption brushes 31 are vertically or horizontally arranged depending on the size of a purifier to be manufactured and each of the adsorption brushes 31 can be rotated D. Desirably, the plurality of pollutant collection plates 33 may be further provided along an inner circumference of the air purification unit 30. Also, desirably, the air purification unit 30 may be installed with the adsorption brush 31 set to the optimal width and height for the size of a purifier to be manufactured.

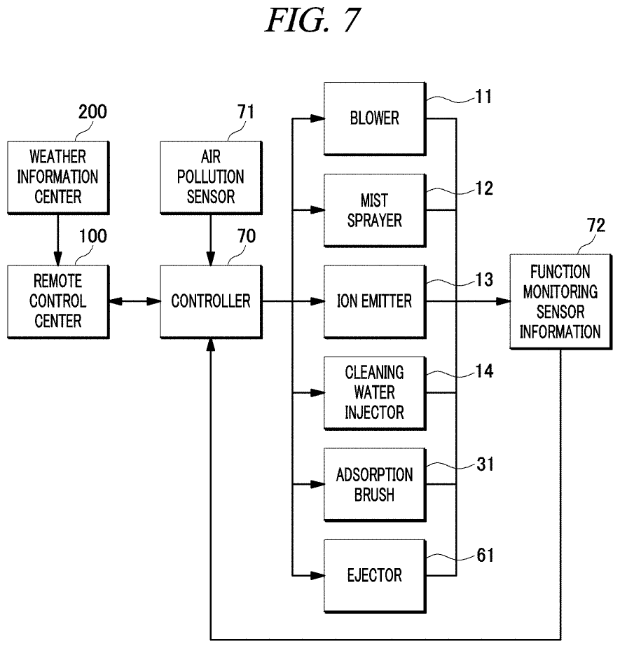

FIG. 7 is a block diagram showing a configuration for controlling each function of the tower type air purifier according to the present disclosure.

Referring to FIG. 7, the tower type air purifier according to the present disclosure may be operated by appropriately controlling the blower 11, the mist sprayer 12, the ion emitter 13, the cleaning water injector 14, the adsorption brush 31 and the ejector 61 according to an air purification algorithm of the controller 70. An air purification process can be appropriately performed according to the air purification algorithm by operating an air pollution sensor 71 to collect air pollution measurement information, collecting function monitoring sensor information 72 through function monitoring sensors of the respective constituent components 11, 12, 13, 14, 31 and 61 to monitor an operation state of the purifier in real time, and periodically injecting cleaning water to the inside to maintain the cleanliness.

Also, the controller 70 may be switched to a remote control mode by a remote control center 100 that receives weather information from a weather information center 200 to perform a control function. In the case of switching to the remote control mode, the constituent components 11, 12, 13, 14, 31 and 61 of the purifier may be remotely controlled to perform an air purification function according to the air purification algorithm of the remote control center 100.

The air purification method performed by the tower type air purifier according to the present disclosure will be described in detail as follows.

The air purification method of the tower type air purifier according to the present disclosure includes: a process of starting control of constituent components according to an air purification algorithm by the controller 70; a process of measuring pollutants in air and a concentration of pollutants by operating the air pollution sensor 71; a process of suctioning outside air by controlling the blower 11 of the air suction unit 10; a process of spraying mist into the suctioned air by controlling the mist sprayer 12 of the air suction unit 10; a process of emitting ions into the suctioned air by controlling the ion emitter 13 of the air suction unit 10; a process of adsorbing and discharging pollutant particles in the air by controlling rotation and electric charging of the adsorption brush 31 of the air purification unit 30; a process of narrowly injecting cleaning water into the suctioned air to clean insides of the adsorption brush 31 and the air purification unit 30 by controlling the cleaning water injector 14 of the air suction unit 10; and a process of discharging the pollutants precipitated in the pollutant precipitation unit 50 by controlling the ejector 61 of the pollutant discharge unit 60 to effectively purify the suctioned air.

FIG. 8 is a flowchart showing an embodiment of an air purification algorithm used as an air purification method of the tower type air purifier according to the present disclosure.

Referring to FIG. 7 and FIG. 8, the air purification algorithm used as the air purification method of the tower type air purifier according to the present disclosure may include the following processes:

(a) a process of starting the air purification algorithm (300);

(b) a process of measuring pollutants in air and a concentration of pollutants by operating the air pollution sensor 71 (310);

(c) a process of collecting the monitoring sensor information 72 of the constituent components inside the purifier (320);

(d) a process of suctioning air by controlling the blower 11 of the air suction unit to vary a volume of air to be suctioned depending on air to be purified (330);

(e) a process of selecting an air purification method according to the air purification algorithm based on the air pollution measurement information of the process (b) (340) (for example, The concentration of fine dust/yellow dust is high? YES if high or NO if low);

(f) a first air purification method for performing an air purification process as follows according to the air purification algorithm if the concentration of fine dust/yellow dust is lower than a set value in the process (e);
(1) a process of emitting ions into the suctioned air by controlling the ion emitter 13 of the air suction unit air suction unit (350)
(2) a process of electrostatically adsorbing pollutant particles in the air by the electrically charged adsorption brush by controlling the adsorption brush 31 of the air purification unit (360)
(3) a process of spraying mist into the suctioned air by controlling the mist sprayer 12 of the air suction unit (370)
(4) a process of adsorbing the pollutant particles and discharging the adsorbed pollutant particles by controlling rotation of the adsorption brush 31 of the air purification unit to vary a rotation speed according to the air purification algorithm (380)
(5) a process of cleaning the insides of the adsorption brush and the air purification unit with the injected cleaning water by controlling the cleaning water injector 14 of the air suction unit (390)
(6) a process of performing air purification by repeating the processes (1) to (5) based on the air pollution measurement information and the monitoring sensor information of the constituent components inside the purifier

(g) a second air purification method for performing an air purification process as follows according to the air purification algorithm if the concentration of fine dust/yellow dust is higher than the set value in the process (e);
(1) a process of spraying mist into the suctioned air by controlling the mist sprayer of the air suction unit
(2) a process of narrowly injecting the cleaning water into the suctioned air (yellow dust high-concentration pollutant particles) to adsorb the pollutant particles in the air and clean the adsorption brush by controlling the cleaning water injector of the air suction unit
(3) a process of adsorbing the pollutant particles and discharging the adsorbed pollutant particles by controlling rotation of the adsorption brush of the air purification unit to vary a rotation speed according to the air purification algorithm
(4) a process of cleaning the insides of the adsorption brush and the air purification unit with the strongly injected cleaning water by controlling the cleaning water injector of the air suction unit
(5) a process of performing air purification by repeating the processes (1) to (4) based on the air pollution measurement information and the monitoring sensor information of the constituent components

(h) a process of discharging the pollutants precipitated on the bottom of the pollutant precipitation unit into a collection container by controlling the ejector of the pollutant discharge unit based on monitoring sensor information of the pollutant precipitation unit.

Rotation and electric charging of the adsorption brush according to the present disclosure are appropriately controlled depending on the type and concentration of pollutants in the suctioned air according to the air purification algorithm. Thus, it is possible to purify the air by quickly adsorbing pollutant particles absorbed by mist particles and electrically charged by ions. Since the tower type air purifier of the present disclosure does not use a general air purification filter, it requires lower operating cost and is easy to maintain. Thus, it is possible to economically purify air pollution.

The tower type air purifier of the present disclosure is a vertical combination of main constituent components composed of an air suction unit (equipped with a mist sprayer, an ion emitter, a cleaning water injector), an air diffusion unit, an air purification unit, a pollutant collection unit, a pollutant precipitation unit and a pollutant discharge unit. A controller independently operates the air purifier according to an air purification algorithm depending on air pollution sensor information or the air purifier is remotely controlled to effectively perform air purification according to an air purification algorithm of a remote control center connected via a network.

### INDUSTRIAL APPLICABILITY

The present disclosure is a tower type air purifier installed and operated outdoors to purify air pollution such as fine dust. The tower type air purifier uses an adsorption brush according to the present disclosure, which can be used semi-permanently, and uses mist particles and ions to purify air in an efficient way. Also, since the tower type air purifier of the present disclosure does not use a general air purification filter, it requires lower operating cost, and since the main constituent components of the tower type air purifier of the present disclosure does are modularized, it is easy to maintain. Thus, it is possible to economically and effectively purify air pollution.

Further, in the tower type air purifier of the present disclosure, the purifier can be operated independently according to an air purification algorithm based on air pollution measurement information or a group of purifiers can be operated through remote control of a weather center according to an air purification algorithm suitable for each air pollution region in order to effective purify fine dust, ultrafine dust, yellow dust, dust and pollen which are types of air pollutants. Therefore, if purifiers are installed and operated all over the country, it is possible to effectively and quickly air pollution in a wide area.

What is claimed is:

1. A tower type air purifier that purifies and discharges air, comprising:
an air suction unit equipped with one or more blowers and configure to suction air;
a mist sprayer provided in the air suction unit and configured to spray mist particles;
an ion emitter provided in the air suction unit and configured to emit ions;
a cleaning water injector provided in the air suction unit and configured to inject cleaning water;
an air diffusion unit provided under the air suction unit and configured to diffuse the suctioned air;
an air purification unit provided under the air diffusion unit and including at least one adsorption brush;
a pollutant collection unit provided under the air purification unit and configured to collect pollutants coming out from the air purification unit;
a pollutant precipitation unit provided under the pollutant collection unit and configured to discharge the purified air through a ventilation opening, collect the pollutants coming out from the pollutant collection unit and precipitate the pollutants; and
a pollutant discharge unit provided under the pollutant precipitation unit and configured to discharge the precipitated pollutants.

2. The tower type air purifier of claim 1, further comprising:
a controller configured to control an operation of at least one of the blower, the mist sprayer, the ion emitter, the cleaning water injector and the adsorption brush according to an air purification algorithm.

3. The tower type air purifier of claim 2, further comprising:
an air pollution sensor configured to provide air pollution measurement information to the controller,
wherein air is purified and discharged through the air suction unit, the air purification unit, the pollutant collection unit and the pollutant precipitation unit according to the air purification algorithm that is prepared based on the pollution measurement information.

4. The tower type air purifier of claim 1,
wherein each of the air suction unit, the pollutant collection unit and the pollutant precipitation unit is formed to have a funnel shape.

5. The tower type air purifier of claim 1,
wherein a separation space having a distance from each other between the pollutant collection unit and the pollutant precipitation unit is formed.

6. The tower type air purifier of claim 2,
wherein the adsorption brush is configured to adsorb pollutant particles in the air while being rotated and a rotation speed is appropriately controlled according to the air purification algorithm.

7. The tower type air purifier of claim 1,
wherein the adsorption brush includes numerous conductive brush pins which are spirally arranged.

8. The tower type air purifier of claim 2,
the adsorption brush is electrically charged under the control of the controller and electrostatically adsorbs pollutant particles electrically charged by ions.

9. The tower type air purifier of claim 1,
wherein the adsorption brush includes brush pins coated with a carbon nanotube material or made of plastic containing a carbon nanotube material.

10. The tower type air purifier of claim 1,
wherein at least two adsorption brushes are vertically or horizontally arranged and individually rotated.

11. The tower type air purifier of claim 1,
wherein a pollutant collection plate configured to collect pollutants, which are discharged from the adsorption brush, is provided along an inner circumference of the air purification unit.

12. The tower type air purifier of claim 1, further comprising:
a waterproof cover located above the blower at a distance from a suction opening of the blower.

13. The tower type air purifier of claim 2,
wherein the controller is connected to a remote control center via a network and switched to a remote control mode, and when the controller is switched to the remote control mode, the controller controls an operation of at least one of the blower, the mist sprayer, the ion emitter, the cleaning water injector and the adsorption brush according to an air purification algorithm of the remote control center.

14. An air purification method of a tower type air purifier, comprising:
a process of starting control by a controller according to an air purification algorithm;
a process of measuring pollutants in air and a concentration of pollutants by operating an air pollution sensor;
a process of suctioning outside air by controlling a blower of an air suction unit;
a process of spraying mist into the suctioned air by controlling a mist sprayer of the air suction unit;
a process of emitting ions into the suctioned air by controlling an ion emitter of the air suction unit;
a process of adsorbing and discharging pollutant particles in the air by controlling rotation and electric charging of an adsorption brush of an air purification unit;
a process of injecting cleaning water into the suctioned air to clean insides of the adsorption brush and the air purification unit by controlling a cleaning water injector of the air suction unit; and
a process of discharging the pollutants precipitated in a pollutant precipitation unit by controlling an ejector of a pollutant discharge unit.

15. The air purification method of claim 14,
wherein the air purification algorithm includes:
(a) a process of starting the air purification algorithm;
(b) a process of measuring pollutants in air and a concentration of pollutants by operating the air pollution sensor;
(c) a process of collecting monitoring sensor information of constituent components inside the purifier;
(d) a process of suctioning air by controlling the blower of the air suction unit to vary a volume of air to be suctioned depending on air to be purified;
(e) a process of selecting an air purification method based on the air pollution measurement information including the pollutants in the air and the concentration of pollutants; and
(f) a process of discharging the pollutants precipitated on the bottom of the pollutant precipitation unit by controlling the ejector of the pollutant discharge unit based on monitoring sensor information of the pollutant precipitation unit.

16. The air purification method of claim 15,
wherein if the concentration of fine dust/yellow dust is lower than a set value in the process of selecting an air purification method, the air purification algorithm is configured to perform:
(1) a process of emitting ions into the suctioned air,
(2) a process of electrostatically adsorbing pollutant particles in the air by the electrically charged adsorption brush by controlling electric charging of the adsorption brush,
(3) a process of spraying mist into the suctioned air,
(4) a process of adsorbing the pollutant particles and discharging the adsorbed pollutant particles by controlling rotation of the adsorption brush to vary a rotation speed,
(5) a process of cleaning the insides of the adsorption brush and the air purification unit, and
repeating the processes (1) to (5) based on the air pollution measurement information and the monitoring sensor information.

17. The air purification method of claim 15,
wherein if the concentration of fine dust/yellow dust is higher than a set value in the process of selecting an air purification method, the air purification algorithm is configured to perform:
(1) a process of spraying mist into the suctioned air;
(2) a process of injecting the cleaning water into the suctioned air to adsorb the pollutant particles in the air and clean the adsorption brush by controlling the cleaning water injector;
(3) a process of adsorbing the pollutant particles and discharging the adsorbed pollutant particles by controlling rotation of the adsorption brush to vary a rotation speed;
(4) a process of cleaning the insides of the adsorption brush and the air purification unit; and
repeating the processes (1) to (4) based on the air pollution measurement information and the monitoring sensor information.
